(19) United States
(12) Patent Application Publication
(10) Pub. No.: US 2013/0024466 A1
(43) Pub. Date: Jan. 24, 2013

(54) SYSTEM EVENT LOGGING SYSTEM

(71) Applicants: Shigehito Omiya, Chigasaki-shi (JP); Kasumi Nakajima, Chigasaki-shi (JP); Hiroshi Kato, Chigasaki-shi (JP); Heng Du, Chigasaki-shi (JP)

(72) Inventors: Shigehito Omiya, Chigasaki-shi (JP); Kasumi Nakajima, Chigasaki-shi (JP); Hiroshi Kato, Chigasaki-shi (JP); Heng Du, Chigasaki-shi (JP)

(73) Assignee: SD CO., LTD., Chigasaki-shi, Kanagawa (JP)

(21) Appl. No.: 13/519,700

(22) PCT Filed: Dec. 27, 2010
(86) PCT No.: PCT/JP10/73518

§ 371 Date: Aug. 20, 2012

(30) Foreign Application Priority Data
Dec. 28, 2009 (JP) 2009-297777

(51) Int. Cl. G06F 17/30

(52) U.S. Cl. 707/754; 707/E17.059

(57) ABSTRACT

Provided is a system event logging system for recoding a log of system events which relate to a process being monitored, the logging system having the aim of selectively recording system events that are necessary for purposes such as the reproduction of operations and excluding system events that are outside the intended purpose. Flag conditions and flag operation instructions are provided for each of the filters in a filter list, and the system event logging system uses the flag conditions as the conditions for applying the filters. When applying the filters, the logging system operates the flags according to the flag operation instructions. Thus, interrelated operation between the filters can be achieved by means of the flags, and also, interrelated operation can be achieved by means of the flags even between the processes performed for the system events.

### CROSS REFERENCE TO RELATED APPLICATIONS

This is a U.S. national stage of application No. PCT/JP2010/073518, filed on 27 Dec. 2010. Priority under 35 U.S.C. §119(a) and 35 U.S.C. §365(b) is claimed from Japanese Application No. 2009-297777, filed 28 Dec. 2009, the disclosure of which are also incorporated herein by reference.

### TECHNICAL FIELD

The present invention relates to a system event logging system which records a log of a system event related to monitoring target process.

### BACKGROUND ART

PTL 1 (“a computer system and an application program operation reproducing method”) discloses “a computer system and an application program operation reproducing method which, when an application program abnormally ends, can correctly reproduce a state of the application program as in an operation upon an abnormal end of the application program without applying a redundant load for reproducing the state to the application program, and can substantially reduce an operation load of the state reproducing operation and an operating time.”

More specifically, an operation is recorded to reproduce the operation.

When a log of a system event is recorded to record the operation, many unnecessary logs are included, and therefore it is difficult in some cases to reproduce the operation from the log.

### CITATION LIST

### Patent Literature

### {PTL 1} JP 2002-024055 A

### SUMMARY OF INVENTION

### Technical Problem

An object is to remove non-target system events, and select and record a system event required to reproduce an operation.

### Solution to Problem

A system event logging system according to the present invention has the following elements including: (1) a decision target event acquiring part which sequentially acquires a system event related to decision target process; (2) a filter list which stores a filter record which associates an event condition, a flag condition, a log write instruction and a flag operation instruction for each filter; (3) a flag memory part which stores a flag value; and (4) a filtering part which repeats processing of sequentially reading a filter record of each of the acquired system event, deciding whether or not the system event satisfies the event condition for each read filter record, deciding whether or not the flag value satisfies the flag condition when the flag condition is further set, writing the system event as a log according to the log write instruction when the event condition and the flag condition are satisfied, and updating the flag value according to the flag operation instruction when the flag operation instruction is further set.

The filter record is further associated with the screen image acquisition instruction, and the filtering part records a screen image according to the screen image acquisition instruction when the event condition and the flag condition are satisfied and the screen image acquisition instruction is set.

A program according to the present invention causes a computer which serves as a system event logging system having: a filter list which stores a filter record which associates an event condition, a flag condition, a log write instruction and a flag operation instruction for each filter; and a flag memory part which stores a flag value to execute the following steps including: (1) a decision target event acquiring step of sequentially acquiring a system event related to decision target process; and (2) a filtering step of repeating processing of sequentially reading a filter record of each of the acquired system event, deciding whether or not the system event satisfies the event condition for each read filter record, deciding whether or not the flag value satisfies the flag condition when the flag condition is further set, writing the system event as a log according to the log write instruction when the event condition and the flag condition are satisfied; and updating the flag value according to the flag operation instruction when the flag operation instruction is further set.

### Advantageous Effect of Invention

When a filter is adapted by providing a flag condition and a flag operation instruction for each filter and using a flag condition as a condition for adapting a filter, the flag is operated according to the flag operation instruction, so that it is possible to interface filters through the flag. Further, it is also possible to realize interface processing through the flag even during processing of the system event.

A screen image acquisition instruction is provided to the filter, so that it is possible to adequately record a screen image in response to an occurrence of the system event.

### BRIEF DESCRIPTION OF THE DRAWINGS

FIG. 1 illustrates a view that illustrates operating environment of a system event logging system;

FIG. 2 illustrates a view that illustrates a processing flow of a logger unit;

FIG. 3 illustrates a view that illustrates a configuration of generating an internal process list;

FIG. 4 illustrates a view that illustrates an internal process list generation processing flow;

FIG. 5 illustrates a view that illustrates a configuration of acquiring a decision target event;

FIG. 6 illustrates a view that illustrates a decision target event acquisition processing flow;

FIG. 7 illustrates a view that illustrates a configuration of filtering;

FIG. 8 illustrates a view that illustrates a filtering processing flow;

FIG. 9 illustrates a view that illustrates a configuration of a system event;

FIG. 10 illustrates a view that illustrates a configuration of a filter list;

FIG. 11 illustrates a view that illustrates a configuration of event conditions;

FIG. 12 illustrates a view that illustrates a configuration of flag conditions;

FIG. 13 illustrates a view that illustrates a configuration of a flag operation instruction;

FIG. 14 illustrates a view that illustrates a configuration of a screen image acquisition instruction;

FIG. 15 illustrates a view that illustrates a configuration of a log write instruction;

FIG. 16 illustrates a view that illustrates a log record (1/2);

FIG. 17 illustrates a view that illustrates a log record (2/2);

FIG. 18 illustrates a view that illustrates a configuration of outputting a log file;

FIG. 19 illustrates a view that illustrates an end process monitoring processing flow;

FIG. 20 illustrates a view that illustrates a configuration of a viewer unit;

FIG. 21 illustrates a view that illustrates a configuration of a viewer filter list;

FIG. 22 illustrates a view that illustrates a processing flow of a viewer unit; and

FIG. 23 illustrates a view that illustrates a hardware configuration of the system event logging system;

### DESCRIPTION OF EMBODIMENTS

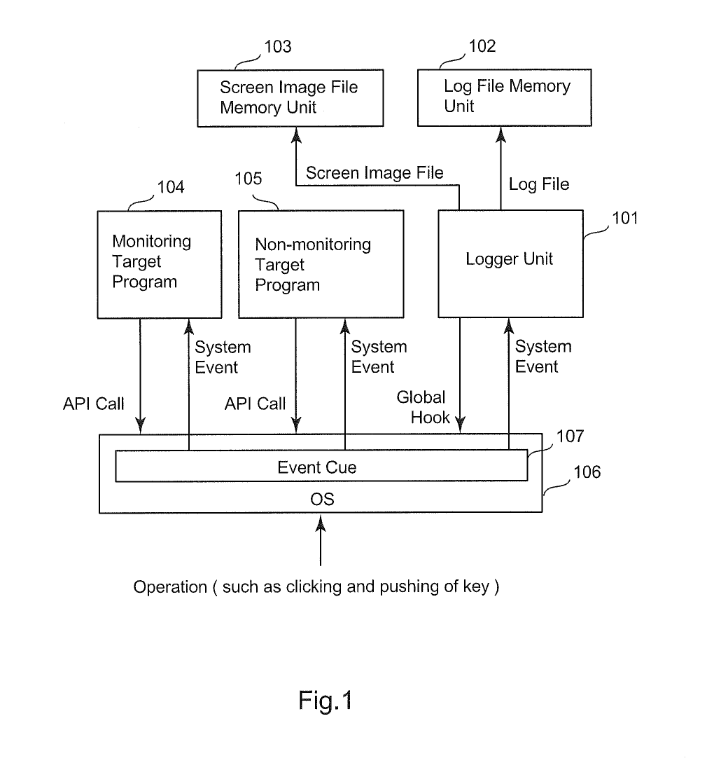

FIG. 1 illustrates a view that illustrates operating environment of a system event logging system. A monitoring target program 104 and a non-monitoring target program 105 operate by acquiring a system event which occurs in response to a user's operation of a keyboard or a mouse according to an API call. The logger unit 101 acquires this system event by means of an event cue 107 in the operation system 106 using a global hook, and selects only predetermined events among events which occur upon an operation of the monitoring target program 104 and store the predetermined events in a log file memory unit 102. Further, the logger unit 101 operates to adequately acquire and store a screen image in a screen image file memory unit 103.

The log file memory unit 102 and the screen image file memory unit 103 are provided in, for example, a memory area of a hard disk device. Further, the logger unit 101, the monitoring target program 104 and the non-monitoring target program 105 are configured to operate by being loaded to a memory and having a program code sequentially read and executed by a computing device.

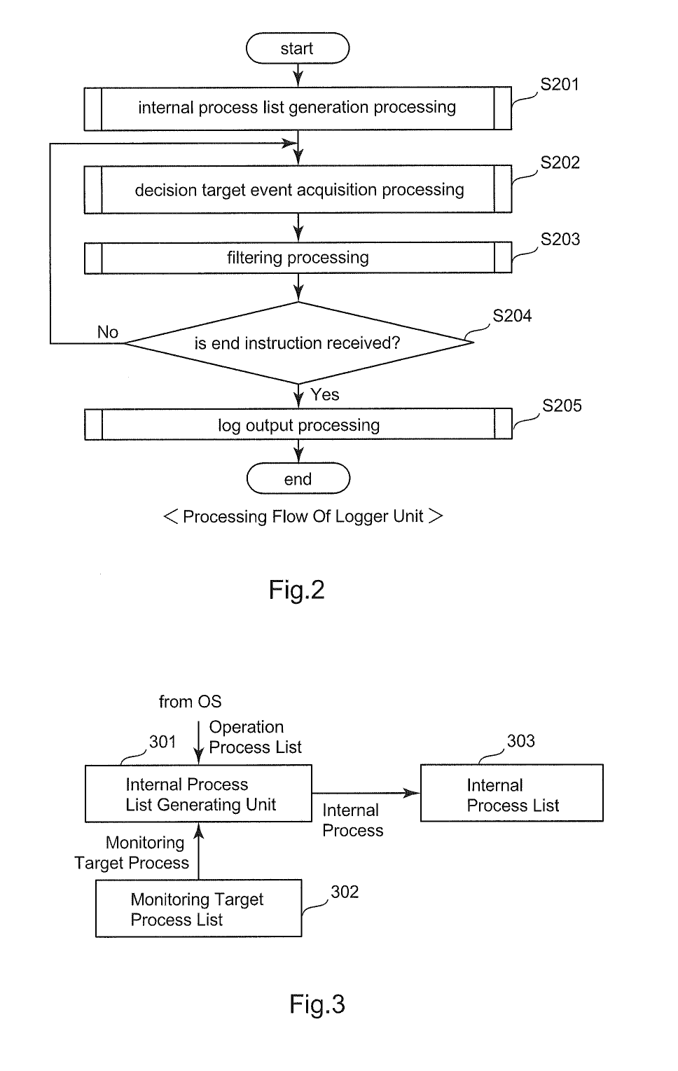

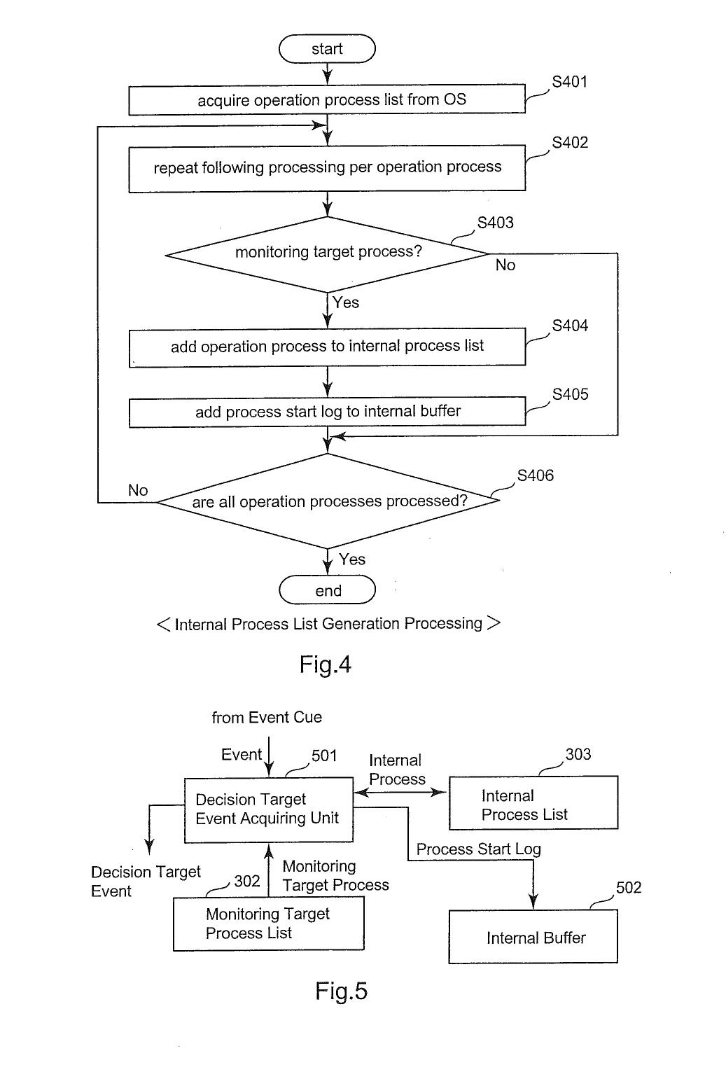

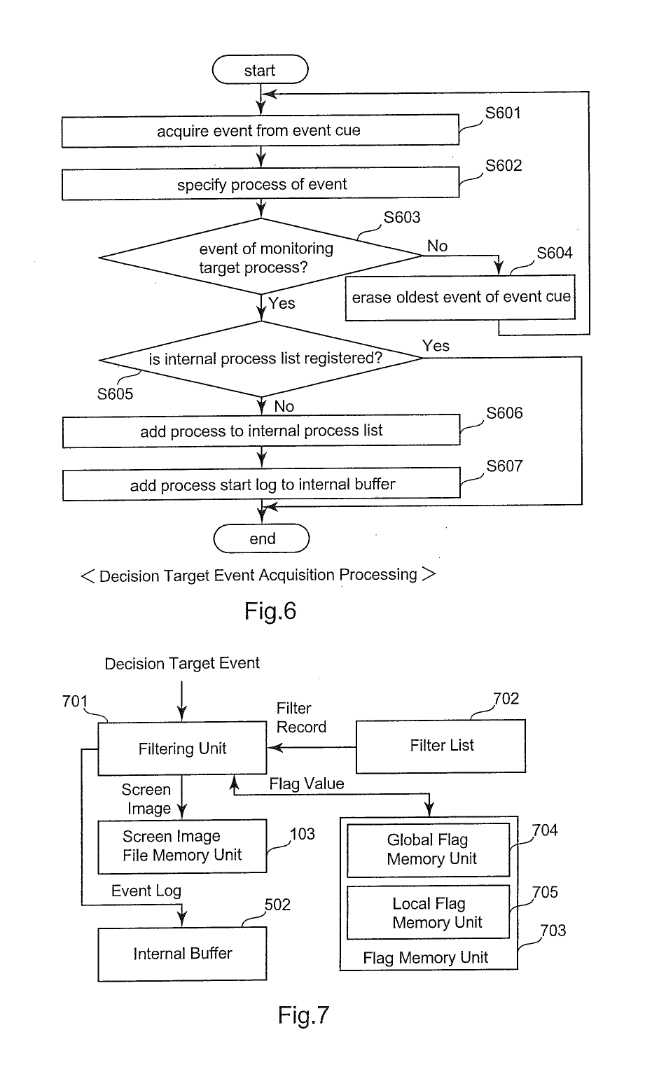

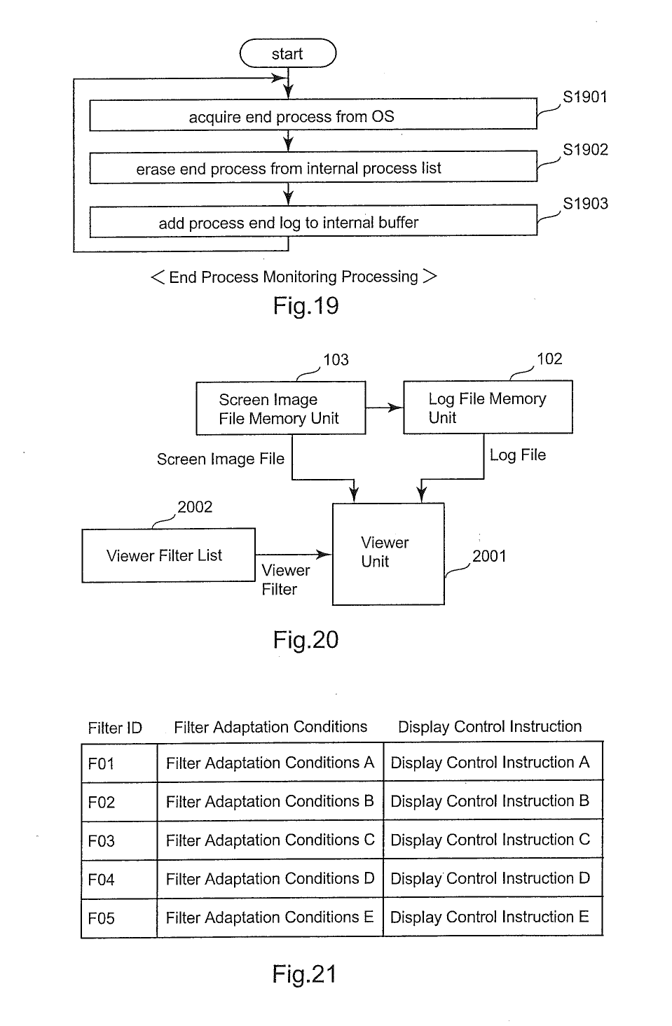

Hereinafter, an operation of the logger unit (logger unit) will be described. FIG. 2 illustrates a view that illustrates a processing flow of the logger unit. When the logger unit 101 is activated, internal process list generation processing (S201) is performed as preprocessing. By this means, the internal process list is generated. Details will be described below using FIGS. 3 and 4. Next, in decision target event acquisition processing (S202), system events of the monitoring target program 104 and the non-monitoring target program 105 which are operating are acquired, and a decision target event is selected. Details will be described below using FIGS. 5 and 6. Subsequently, in filtering processing (S203), an operation is performed of extracting an event according to a filter list and accumulating the event in an internal buffer as a log. Details will be described below using FIGS. 7 to 17. Further, until an end instruction is received (S204), the decision target event acquisition processing (S202) and the filtering processing (S203) are performed. When the end instruction is received (S204), processing of outputting the log accumulated in the internal buffer as a log file is performed in log output processing (S205). Details will be described below using FIG. 18. Further, in addition to the processing in FIG. 2, end process monitoring processing is operating as another asynchronous task. Details will be described below using FIG. 19.

First, the internal process list generation processing (S201) will be described. FIG. 3 illustrates a view that illustrates a configuration of generating an internal process list. The logger unit 101 has an internal process list generating unit 301, a monitoring target process list 302 and an internal process list 303. The internal process list generating unit 301 performs processing of acquiring an operation process list from an OS, and registering operating process corresponding to the monitoring target process (corresponding to the monitoring target program 104) stored in the monitoring target process list 302, in the internal process list 303. Processes corresponding to one or a plurality of monitoring target programs are registered in the monitoring target process list 302 in advance.

FIG. 4 illustrates a view that illustrates an internal process list generation processing flow. First, an operation process list is acquired from an OS (S401), and the following processing is repeated for each operation process included in the operation process list (S402). When operation process corresponds to one of monitoring target processes in the monitoring target process list 302 (S403), the operation process is added to the internal process list (S404). Further, a process start log is added to the internal buffer (S405). Furthermore, processing ends when all operation processes are processed (S406). By this means, the process of the monitoring targets which has been already activated and which is operating is registered in the internal process list.

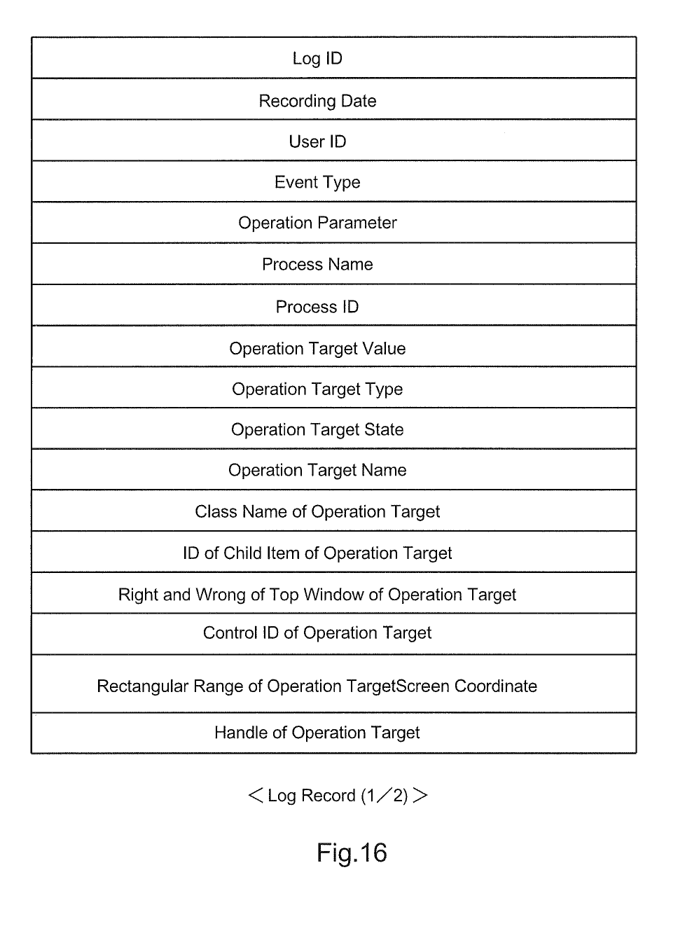

In a process start log, a recording date and, in addition, “start application” as an event type, a specific name of a process name, a specific value of a process ID, “application” as an operation target value and “process” as a class name of the operation target are recorded. A configuration of a log will be described below using FIG. 16.

Next, the decision target event acquisition processing (S202) will be described. FIG. 5 illustrates a view that illustrates a configuration of acquiring a decision target event. The logger unit 101 has a decision target event acquiring unit 501 and an internal buffer 502 in addition to the above internal process list 302 and the monitoring target process list 303. The decision target event acquiring unit 501 acquires a system event from an event cue in order of occurrence, and extracts a decision target event. Further, when the monitoring target process is newly activated, processing of adding this process to the internal process list 303 is performed.

FIG. 6 illustrates a view that illustrates a decision target event acquisition processing flow. First, a system event is acquired from an event cue utilizing a global hook (S601). Further, process of the event is specified (S602). Whether or not the specified process is an event of the monitoring target process (S603) and, when the process does not correspond to one of the monitoring target processes included in the monitoring target process list 302, the oldest system event of the event cue is erased (S604), and the step returns to processing of 5601 again. By contrast with this, when the process corresponds to one of the monitoring target processes, whether or not this process is registered in the internal process list is decided (S605). When the process is not registered, this process is added to the internal process list (S606). Further, a process start log is added to the internal buffer (S607). On the other hand, when the process is already registered, processing is then finished.

Subsequently, the filtering processing (S203) will be described. FIG. 7 illustrates a view that illustrates a configuration of filtering. The logger unit 101 has a filtering unit 701, a filter list 702 and a flag memory unit 703 (a global flag memory unit 704 and a local flag memory unit 705) in addition to the above screen image file memory unit 103 and the internal buffer 502. In the filter list 702, a plurality of filters are stored in order of processing. The filtering unit 701 sequentially reads filters, compares conditions of the decision target event and conditions of a filter according to content of the filter, decides the flag of the local flag memory unit 705, updates the flag in the local flag memory unit 705, stores a screen image in the screen image file memory unit 103, and additionally writes content of an event in the internal buffer 502 as a log.

The global flag memory unit 704 of the flag memory unit 703 is a flag which is commonly operated by each process or is compared. By contrast with this, the local memory unit 705 is a flag to which one process is dedicated. Further, the global flag memory unit 704 is configured to have a plurality of flags, and be specified, operated or compared according to a global flag ID. Similarly, the local flag memory unit 705 is also configured to have a plurality of flags, and be specified, operated and compared according to a local flag ID.

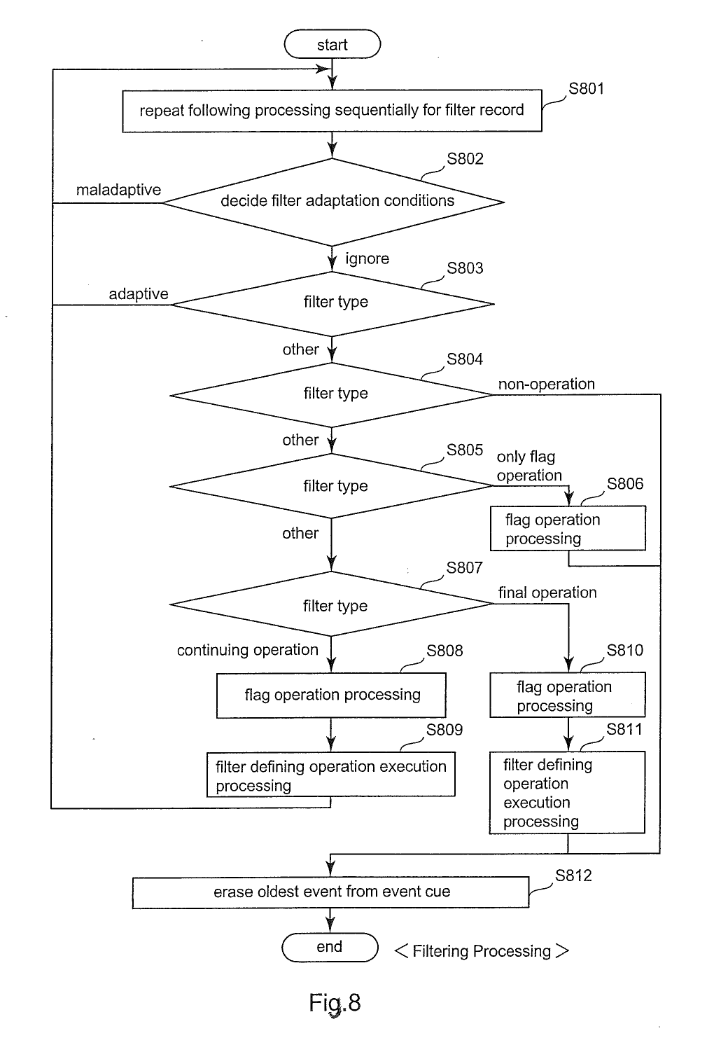

FIG. 8 illustrates a view that illustrates a filtering processing flow. Filter records are sequentially read from the filter list 702, and the following processing for a decision target event is performed (S801). First, in filter adaptation condition decision processing, whether or not a decision target event adapts to filter adaptation conditions is decided (S802).

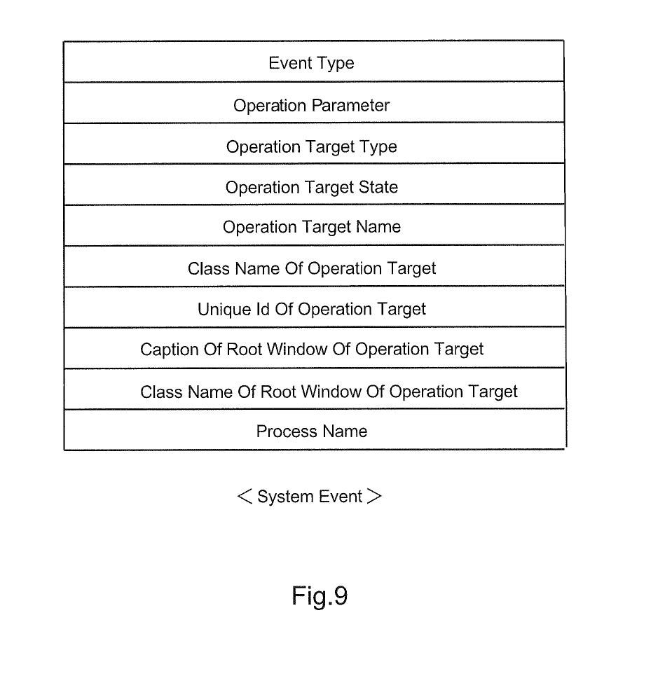

Hereinafter, configurations of a system event and a filter list will be described. FIG. 9 illustrates a view that illustrates a configuration of the system event. The system event includes items of an event type: EventID, an operation parameter: Params, an operation target type: ElementTypeID, an operation target state: Status, an operation target name: ElementName, a class name of the operation target: ClassName, a unique ID of the operation target: ControlID, a caption of a root window of the operation target: RootName, a class name of the root window of the operation target: RootClassName and a process name: ProcessName.

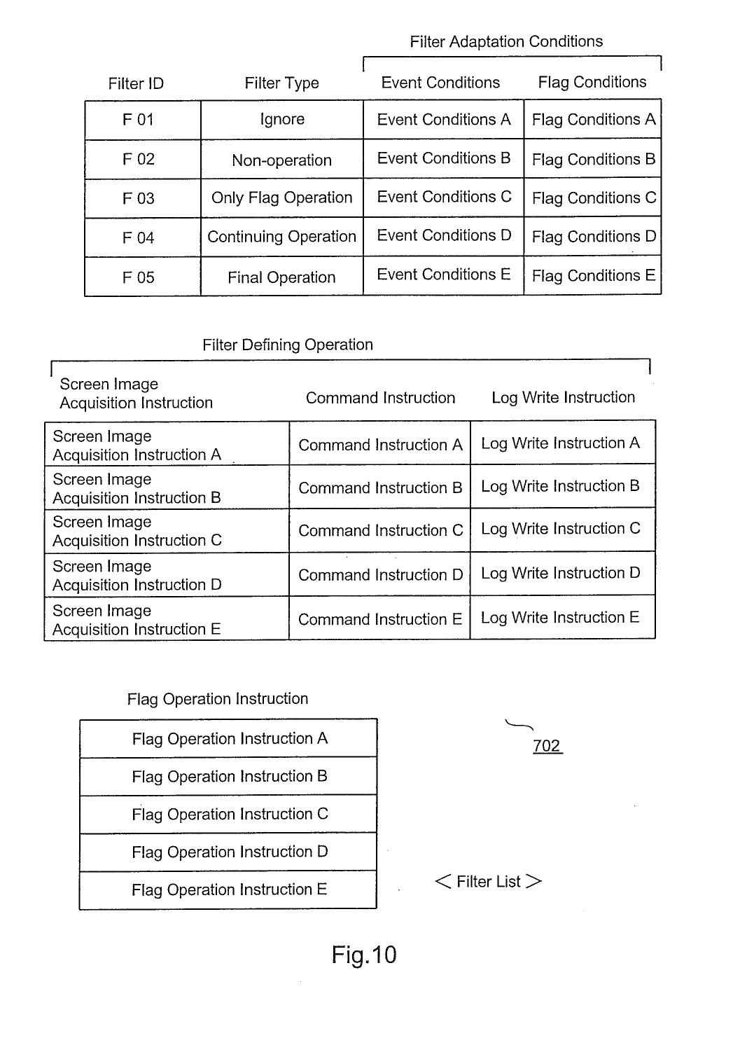

FIG. 10 illustrates a view that illustrates a configuration of the filter list. A filter record is provided for each filter in processing order, and the filter has items of a filter ID, a filter type, filter adaptation conditions (event conditions and flag conditions) and filter defining operations (a screen image acquisition instruction, a command instruction, a log write instruction and a flag operation instruction).

In filter adaptation condition decision processing (S802), whether or not the decision target event adapts to the filter adaptation conditions is decided. It is decided that the decision target event is adaptive when the decision target event matches with the event conditions and matches with the flag conditions. In addition, when the flag conditions are not set, decision is made only for the event conditions.

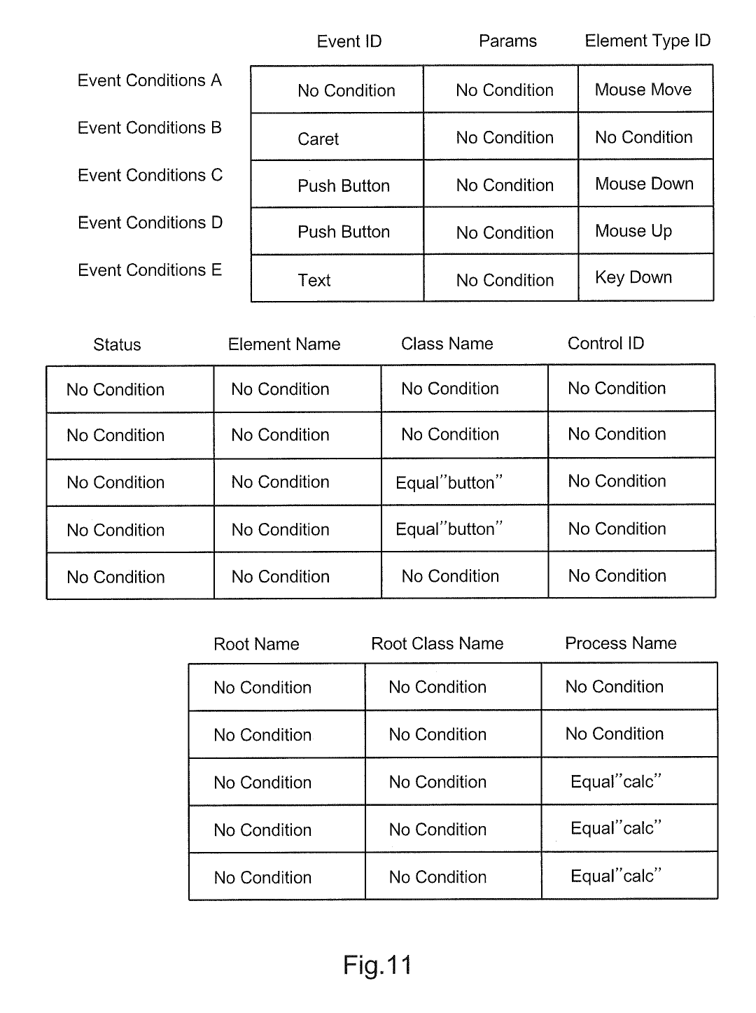

Decision of the event conditions will be described. FIG. 11 illustrates a view that illustrates a configuration of the event conditions. Conditions are configured to be set for each item of the system event. Except the item of no condition, each item is decided according to AND conditions. It is also possible to specify a left-hand match, a right-hand match and a partial match in addition to a perfect match.

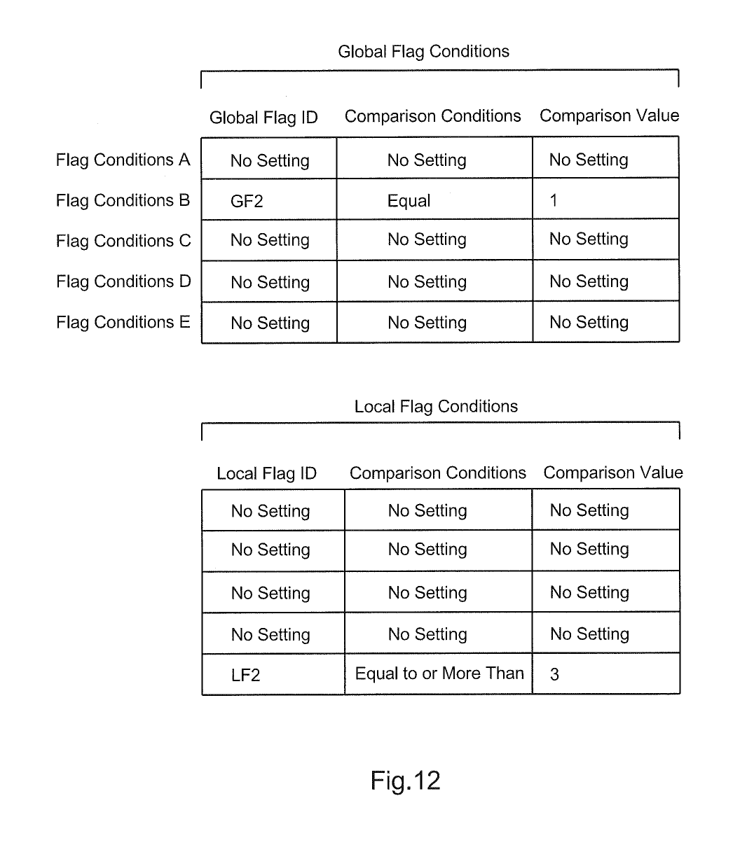

Decision of the flag conditions will be described. FIG. 12 illustrates a view that illustrates a configuration of the flag conditions. Except an item of no setting, when the global flag conditions and the local flag conditions are adaptive, it is decided that the overall flag conditions are adaptive. The global flag conditions include a global flag ID, comparison conditions and a comparison value. A value of a flag specified according to the global flag ID is read from the global flag memory unit 704 and, when the flag value satisfies the comparison conditions compared to the comparison value, it is decided that the global conditions are adaptive. Conditions such as “equal”, “not equal”, “equal to or more than”, “equal to or less than”, “smaller than” or “higher than” can be set to the comparison conditions. Similarly, the local flag conditions include a global flag ID, comparison conditions and a comparison value, and, when a value of a flag specified according to a local flag ID is read from the local flag memory unit 705 and the flag value satisfies the comparison conditions compared to the comparison value, it is decided that the local flag conditions are adaptive. The same applies to the comparison conditions.

When the conditions are decided as maladaptive based on these decisions according to filter adaptation condition decision processing (S802), the step returns to S801 to proceed to processing of the next filter record. When the conditions are decided as adaptive (S802), the step proceeds to processing for each filter type. When the filter type is “ignore” (S803), the step returns to S801 to proceed to processing of the next filter record.

When the filter type is “non-operation” (S804), filtering processing ends without returning to S801. When the filter type is “only flag operation” (S805), flag operation processing (S806) is performed, the oldest event of the event cue is erased (S812) and filtering processing ends. When the filter type is “continuing operation” (S807), flag operation processing (S808) and filter defining operation execution processing (S809) are performed, and the step returns to S801 to proceed processing of the next filter record. When the filter type is “final operation” (S807), flag operation processing (S810) and filter defining operation execution processing (S811) are performed, the oldest event of the event cue is erased (S812), and filtering processing is finished.

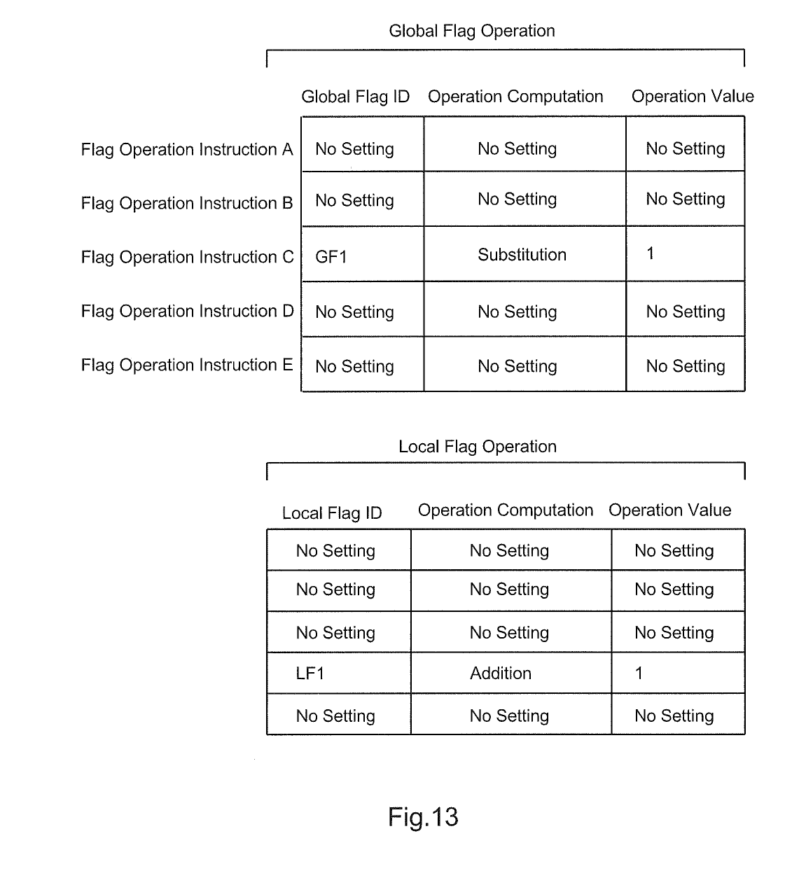

The above flag operation processing will be described. According to this processing, a flag operation instruction of a filter is executed. FIG. 13 illustrates a view that illustrates a configuration of a flag operation instruction. The flag operation instruction is configured with the global flag operation and the local flag operation, and is directed to performing the instructed flag operation except no setting. The global flag operation includes a global flag ID, operation computation and an operation value. A flag value specified according to the global flag ID is read from the global flag memory unit 704, the operation value is computed for the read flag value, and a computation result is written in the flag value specified according to the global flag ID. In the operation computation, computation such as substitution, addition, subtraction, multiplication or division can be set. Similarly, the local flag operation also includes a local flag ID, operation computation and an operation value, and is directed to reading a flag value specified according to the local flag ID from the local flag memory unit 705, computes the operation value for the read flag value and writes the computation result in the flag value specified according to the local flag ID. The flag value is updated in this way.

The above filter defining operation execution processing will be described. In this processing, processing of a screen image acquisition instruction, processing of a command instruction and processing of a log write command included in a filter defining operation of the filter are executed. No processing is performed according to each instruction in case of no setting.

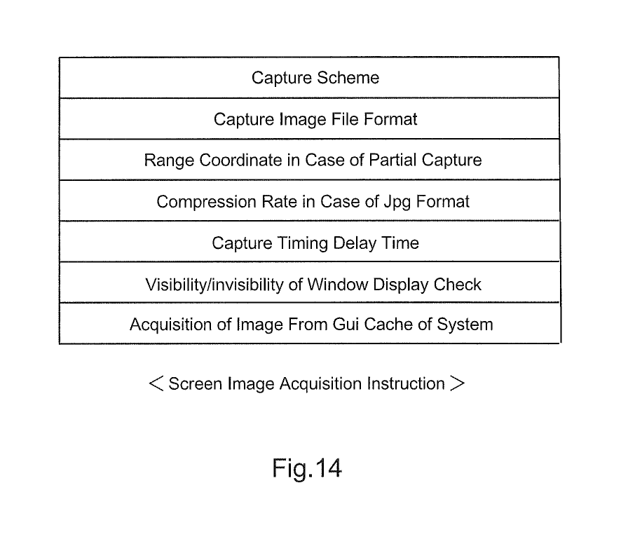

FIG. 14 illustrates a view that illustrates a configuration of the screen image acquisition instruction. The screen image acquisition instruction includes items of a capture scheme: SnapshotType, a capture image file format: SnapshotFormat, a range coordinate of partial capture: TargetRect, a compression rate of a Jpg format: JpegQuality, a capture timing delay time (ms): Delay, visibility/invisibility of window display check: IsCheckVisible, and acquisition of an image from a GUI cache of a system: IsUseGUICache. According to conditions of these items, a screen image is acquired through an OS, and is stored in the screen image file memory unit 103 as a screen image file.

Identification information of a hot key can be set to an item of a command instruction of a filter. In processing of a command instruction, identification information of a hot key is read from the item of this command instruction, and an operation matching this hot key is activated through the OS.

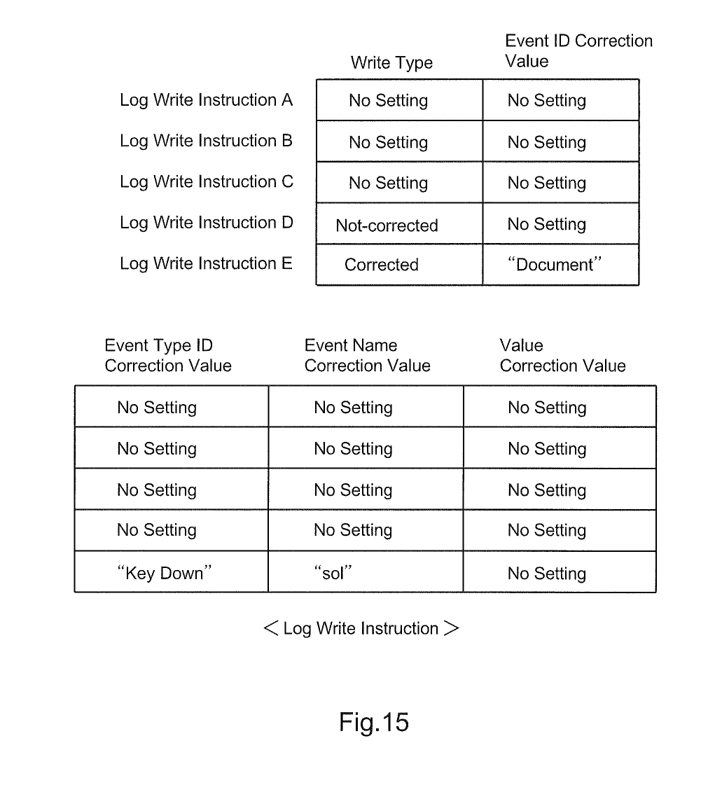

FIG. 15 illustrates a view that illustrates a configuration of a log write instruction. In the write type, one of “not-corrected”, “corrected” and “not-corrected and corrected” can be set. In case of “not-corrected”, information of each item of the system event is written in the internal buffer 502 as a log. In case of “corrected”, an EventID correction value, an EventTypeID correction value, an EventName correction value and a Value correction value are written in each corresponding item as logs except an item of no setting, and an item value of a system event is written in other items. Further, in case of “not-corrected and corrected”, two logs of a log corresponding to “not-corrected” and a log corresponding to “corrected” are recorded.

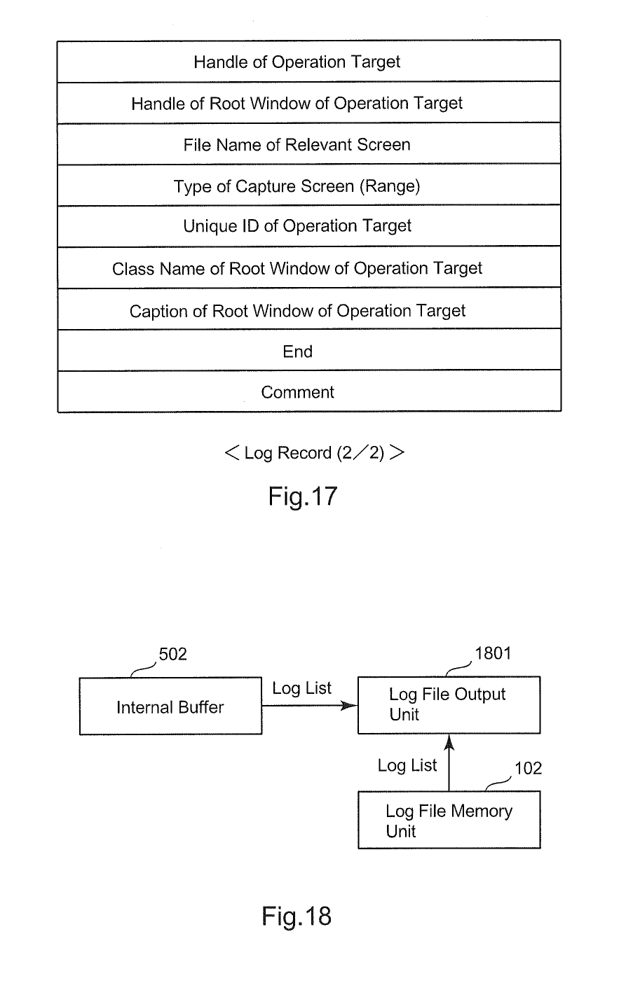

Meanwhile, a configuration of a log record will be described. FIGS. 16 and 17 illustrate views that illustrate a configuration of a log record. The log record includes items of a log ID: LogID, a recording date: DateTime, a user ID: UserID, an event type: EventID, an operation parameter: Params, a process name: ProcessName, a process ID: ProcessID, an operation target value: Value, an operation target type: ElementTypeID, an operation target state: Status, an operation target name: ElementName, a class name of the operation target: ClassName, an ID of a child item of the operation target: ChildID, right and wrong of a top window of the operation target: IsTopWindow, a control ID of the operation target: Rect, a rectangular range of the operation target (screen coordinate): RootRect, handle of the operation target: Handle, handle of the operation target: RootHandle, handle of a root window of the operation target: LinkImage, a file name of a relevant screen: LinkImage, a type of a capture screen (range): SnapshotType, a unique ID of the operation target: ControlID, a class name of a root window of the operation target: RootClassName, a caption of the root window of the operation target: RootName, an end: End, and a comment: Comment. Items which are not included in the system event can be effectively acquired as necessary through, for example, the OS and stored.

The log output processing (S205) of outputting logs accumulated in the above processing will be described. FIG. 18 illustrates a view that illustrates a configuration of outputting a log file. The logger unit 101 has a log file output unit 1801 in addition to the above log file memory unit 102 and the internal buffer 502. The log file output unit 1801 reads a log list including a series of logs from the internal buffer 502, and stores the log list in a file format in the log file memory unit 102.

The logger unit 101 further performs end process monitoring processing according to an asynchronous task. According to this processing, that process has ended is recorded in the log. FIG. 19 illustrates a view that illustrates an end process monitoring processing flow. When the end process is acquired from the OS (S1901), the end process is erased from the internal process list 303 (S1902). Further, the process end log is added to the internal buffer (S1903).

In the process end log, a recording date and, in addition, “application end” as an event type, a specific name of a process name, a specific value of a process ID, “application” as an operation target value and “process” as a class name of the operation target are recorded. This log is also recorded in the log file memory unit 102 as part of the log list.

The log file and the screen image file accumulated in the above processing can be displayed by the viewer unit. FIG. 20 illustrates a view that illustrates a configuration of the viewer unit. A viewer unit 2001 reads the log file from the log file memory unit 102, reads a screen image file from the screen image file memory unit 103, and outputs, for example, displays the screen image file according to an instruction of a viewer filter list 2002.

FIG. 21 illustrates a view that illustrates a configuration of a viewer filter list. A record is provided for each filter, and a filter ID, filter adaptation conditions and a display control instruction are associated and stored. The filter adaptation conditions are set for each item of a log. In the display control instruction, an instruction for displaying the log is set.

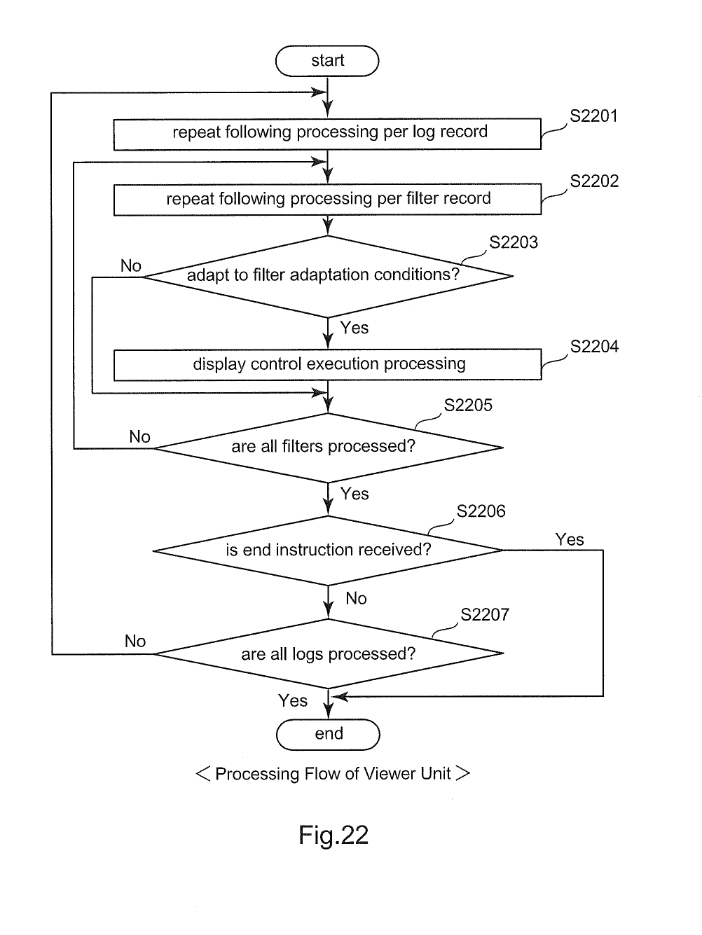

FIG. 22 illustrates a view that illustrates a processing flow of the viewer unit. The following processing is repeated for each log record of a log file of the log file memory unit 102 (S2201). When the following processing is repeated for each filter record (S2202) and the log adapts to the filter adaptation conditions (S2203), display processing related to the log is executed according to the display control instruction (S2204). In this case, when a screen display instruction is included, a screen image file is read and displayed according to this instruction. Further, if all filters are processed (S2205) and an end instruction is not received (S2206), the step returns to S2201 to proceed to processing related to the next log. These processings end at a point of time when these processings are applied to all logs (S2207). When the end instruction is received, processing ends at this point of time.

In addition, the operation of the viewer unit can be executed by a computer separate from the logger unit. In this case, a log file and a screen image file recorded in the logger unit are duplicated to a computer of a viewer unit, and referred to.

The system event logging system is a computer, and each element can execute processing according to a program. Further, it is possible to store the program in a storage medium and make a computer read the program from the storage medium.

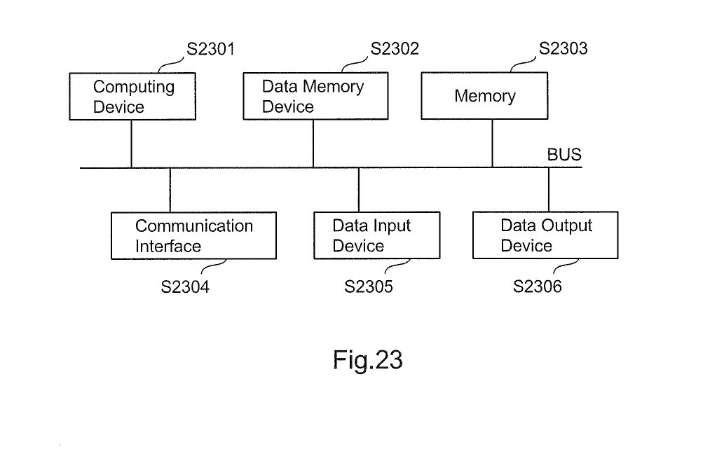

A hardware configuration of the system event logging system will be described. FIG. 23 illustrates a view that illustrates the hardware configuration of the system event logging system. A computing device 2301, a data memory device 2302, a memory 2303, a communication interface 2304, a data input device 2305 and a data output device 2306 are connected to a bus. The data memory device 2303 is, for example, a ROM (Read Only Memory) or a hard disk. The memory 2303 is generally a RAM (Random Access Memory). The program is generally stored in the data memory device 2302, and is sequentially read by the computing device 2301 in a state where the program is loaded to the memory 2303 to perform processing. The communication interface 2304 is used for communication through a network. The data input device 2305 is used to input data. The data output device 2306 is used to output (display or print) data.

1. A system event logging system comprising:
(1) a decision target event acquiring part which sequentially acquires a system event related to decision target process;
(2) a filter list which stores a filter record which associates an event condition, a flag condition, a log write instruction and a flag operation instruction for each filter;
(3) a flag memory part which stores a flag value; and
(4) a filtering part which repeats processing of sequentially reading a filter record of each of the acquired system event, deciding whether or not the system event satisfies the event condition for each read filter record, deciding whether or not the flag value satisfies the flag condition when the flag condition is further set, writing the system event as a log according to the log write instruction when the event condition and the flag condition are satisfied, and updating the flag value according to the flag operation instruction when the flag operation instruction is further set.

2. The system event logging system according to claim 1, wherein:
the filter record is further associated with the screen image acquisition instruction; and
the filtering part records a screen image according to the screen image acquisition instruction when the event condition and the flag condition are satisfied and the screen image acquisition instruction is set.

3. A program causing a computer which serves as a system event logging system comprising: a filter list which stores a filter record which associates an event condition, a flag condition, a log write instruction and a flag operation instruction for each filter; and a flag memory part which stores a flag value to execute:
(1) a decision target event acquiring step of sequentially acquiring a system event related to decision target process; and
(2) a filtering step of repeating processing of sequentially reading a filter record of each of the acquired system event, deciding whether or not the system event satisfies the event condition for each read filter record, deciding whether or not the flag value satisfies the flag condition when the flag condition is further set, writing the system event as a log according to the log write instruction when the event condition and the flag condition are satisfied; and updating the flag value according to the flag operation instruction when the flag operation instruction is further set.
